(19) United States
(12) Patent Application Publication
(10) Pub. No.: US 2014/0101719 A1
(43) Pub. Date: Apr. 10, 2014

(54) SYSTEMS AND METHODS FOR PROVIDING A NETWORK STORAGE SYSTEM

(71) Applicant: APPSENSE LIMITED, Warrington (GB)

(72) Inventors: Karthik Lakshminarayanan, Cupertino, CA (US); Joseph Saib, Santa Clara, CA (US); Michael Mills, Aurora, IL (US); Harpreet Singh Labana, Millwood, NY (US)

(73) Assignee: AppSense Limited, Warrington (GB)

(21) Appl. No.: 13/648,686

(22) Filed: Oct. 10, 2012

(51) Int. Cl. G06F 21/00

(52) U.S. Cl. 726/3

(57) ABSTRACT

Systems and methods are provided for providing a network storage system. One method includes receiving a request from a client coupled to a local communication network to provide access to a network storage system. The request can include a data item identifier, and the network storage system can include a local network storage, coupled to the local communication network, and a remote network storage, coupled to a public communication network. The method can further include identifying, based on the request, one of the local network storage and the remote network storage for serving the request, and providing the request to the identified one of the local network storage and the remote network storage to provide the client with an access to the identified one of the local network storage and the remote network storage.

### BACKGROUND

1. Technical Field

Disclosed systems and methods relate to providing a network storage system.

2. Description of the Related Art

Traditionally, computing devices managed data files locally. For example, a computer stored data files on a local storage medium and accessed the contents of the data files by retrieving them from the local storage medium. Oftentimes, the local storage medium could only be accessed by the computing device being physically coupled to the storage medium. Therefore, the management of data files on a local storage medium was largely independent of other computing devices. Such a local data file management had some benefits, one of which includes the speed at which data files could be stored and accessed.

However, the local management of data files rendered certain data management tasks cumbersome, especially the sharing of data files amongst multiple computing devices.

For example, every time a user wanted to provide a data file to another computer, the user had to copy the data file into a portable storage medium, such as a portable hard disk or a Universal Serial Bus (USB) drive, and copy the data file in the portable storage medium to the destination computing device. Because this mechanism involves a physical coupling of the portable storage medium to the destination computing device, sharing of data files was slow, involved a lot of user interaction, and was at best cumbersome.

Some of these issues have been addressed with network storages in communication networks. A network storage system allows clients, such as computers, to access data files stored in remote network storages via communication networks. Such a remote data access allows users to store data files at a remote network storage and access those files from any clients that are coupled to the remote network storage.

Maintaining data at a remote network storage comes at the expense of reduced security. Because the remote network storage can be accessed from any clients via communication networks, a third party attacker can easily attempt to access data in the remote network storage. Third party attacks can be addressed by imposing certain security measures. While certain security measures can reduce the risk of third party security breaches, the security measures cannot completely thwart the security breaches. Even if third party attacks can be completely thwarted, the risk of security breaches still remains because oftentimes, a remote network storage is operated by a third party vendor and the third party vendor can potentially gain access to the stored data. Therefore, the network storage systems are inherently more exposed to security breaches compared to local storage systems.

Therefore, there is a need in the art to provide systems and methods for improving security in a network storage system. Accordingly, it is desirable to provide methods and systems that overcome these and other deficiencies of the related art.

### SUMMARY

In accordance with the disclosed subject matter, systems and methods are provided for providing a network storage system.

The disclosed subject matter includes a method. The method can include receiving, at a server, a request from a client coupled to a local communication network to provide access to a network storage system, wherein the request includes a data item identifier, wherein the network storage system includes a local network storage, coupled to the local communication network, and a remote network storage, coupled to a public communication network. The method can further include identifying, at the server, based on the request, one of the local network storage and the remote network storage for serving the request, and providing the request to the identified one of the local network storage and the remote network storage to provide the client with an access to the identified one of the local network storage and the remote network storage.

The disclosed subject matter also includes an apparatus for providing a network storage system. The apparatus can include one or more interfaces configured to provide communication with a client device and the network storage system, where the network storage system includes a local network storage, coupled to a local communication network, and a remote network storage, coupled to a public communication network. The apparatus can also include a processor, in communication with the one or more interfaces, configured to run a module stored in memory that is configured to receive a request, from the client, to provide access to the network storage system, wherein the request includes a data item identifier, identify, based on the request, one of the local network storage and the remote network storage for serving the request, and provide the request to the identified one of the local network storage and the remote network storage to provide the client with an access to the identified one of the local network storage and the remote network storage.

The disclosed subject matter further includes a non-transitory computer readable medium. The computer readable medium can have executable instructions operable to cause an apparatus to receive a request, from a client, to provide access to a network storage system, where the request includes a data item identifier, and where the network storage system includes a local network storage, coupled to a local communication network, and a remote network storage, coupled to a public communication network. The computer readable medium can further include executable instructions operable to cause the apparatus to identify, based on the request, one of the local network storage and the remote network storage for serving the request, and provide the request to the identified one of the local network storage and the remote network storage to provide the client with an access to the identified one of the local network storage and the remote network storage.

In one aspect, the request to provide access to the network storage system includes a store request to store a data item in the network storage system. The store request can include the data item to be stored.

In one aspect, the method, the apparatus, or the non-transitory computer readable medium can include steps, modules, or executable instructions for analyzing the data item in the request to identify one of the local network storage and the remote network storage.

In one aspect, the method, the apparatus, or the non-transitory computer readable medium can include steps, modules, or executable instructions for determining a type of the data item to analyze the data item in the request.

In one aspect, the method, the apparatus, or the non-transitory computer readable medium can include steps, modules, or executable instructions for identifying the local network storage to serve the request, if the determined type of the data item is a file type.

In one aspect, the method, the apparatus, or the non-transitory computer readable medium can include steps, modules, or executable instructions for providing a correspondence table, the correspondence table configured to maintain an entry indicating a correspondence between the data item identifier and a storage device identifier of the network storage system configured to maintain the data item.

In one aspect, the method, the apparatus, or the non-transitory computer readable medium can include steps, modules, or executable instructions for determining a network from which the client sent the request to identify one of the local network storage and the remote network storage.

In one aspect, the method, the apparatus, or the non-transitory computer readable medium can include steps, modules, or executable instructions for identifying the local network storage for serving the request if the client sent the request from the local communication network.

In one aspect, the method, the apparatus, or the non-transitory computer readable medium can include steps, modules, or executable instructions for analyzing a privacy setting of the client from which the request is received to identify one of the local network storage and the remote network storage.

In one aspect, the method, the apparatus, or the non-transitory computer readable medium can include steps, modules, or executable instructions for analyzing a type of a data item associated with the data item identifier to identify one of the local network storage and the remote network storage.

In one aspect, the method, the apparatus, or the non-transitory computer readable medium can include steps, modules, or executable instructions for identifying the local network storage for serving the request if the type of the data item is a file.

In one aspect, the local network storage includes a distributed storage system.

In one aspect, the local communication network includes a local area network, a private communication network, or a virtual private network.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a diagram of a networked communication system in accordance with an embodiment of the disclosed subject matter.

FIG. 2 illustrates a correspondence table in accordance with certain embodiments of the disclosed subject matter.

FIG. 3 is a flow diagram illustrating an operation of a server when a client requests the server to store a data item in accordance with certain embodiments of the disclosed subject matter.

FIG. 4 is a flow diagram illustrating an operation of a server when a client requests the server to retrieve a data item in accordance with certain embodiments of the disclosed subject matter.

FIG. 5 is a block diagram of a server device in accordance with certain embodiments of the disclosed subject matter.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are exemplary, and that it is contemplated that there are other systems and methods that are within the scope of the disclosed subject matter.

The disclosed subject matter relates to systems and methods for providing a network storage system that is more robust to security breaches compared to existing network storage systems. In particular, the disclosed network storage system includes two types of network storages: a remote network storage and a local network storage. The remote network storage can be coupled to a public network, and it can be accessed from any types of networks, including the Internet. In contrast, the local network storage can be coupled to a local network, and may only be accessed by certain clients. For example, the local storage device can be coupled to a corporate local area network (LAN), and may only be accessed by computers coupled to the corporate LAN. In some cases, the local network storage can be operated by an entity that owns the data stored in the local network storage. Therefore, the third party vendor providing the network storage service may not be able to access information stored in the local network storage. Such an exclusive nature of the local network storage can render the disclosed system and methods more secure compared to the remote network storage.

The systems and methods provided in the present disclosure can exploit these characteristics to improve the security of a network storage system. The disclosed storage system can include a proxy server that can intermediate access to network storages. For example, when a client wants to store a data item in a network storage system, the client can send a request to the proxy server to store the data item. In response, the proxy server can determine whether the data item should be stored in a local network storage or a remote network storage, and coordinate the storing of the data item in the determined network storage.

Such a hybrid solution is especially attractive to enterprise systems that are installed at the company site. Oftentimes, companies are reluctant to host all of their data offsite with a third party network storage provider because there is a chance that the service provider can access their confidential information. The disclosed systems and methods can address such security concerns by configuring the proxy server to store important information in a local network storage that can be maintained at the company site and to store less confidential information in a remote network storage.

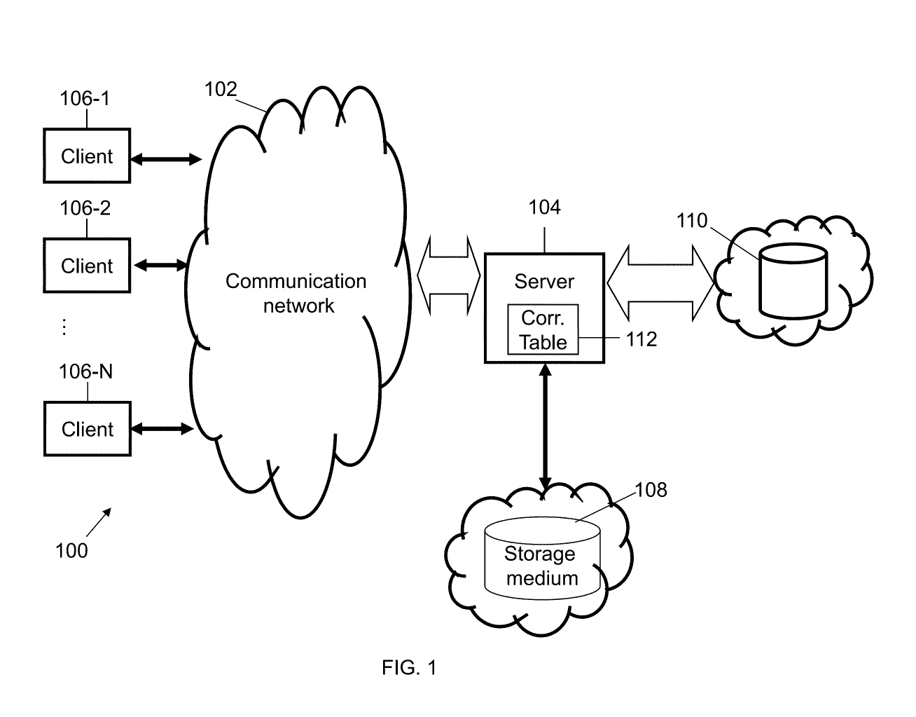

FIG. 1 illustrates a diagram of a networked communication arrangement in accordance with an embodiment of the disclosed subject matter. The networked communication arrangement 100 can include a communication network 102, a server 104, and at least one client 106 (e.g., client 106-1, 106-2, . . . 106-N), a local network storage 108, a remote network storage 110, and a correspondence table 112.

Each client 106 can send data to, and receive data from, the server 104 over the communication network 102. Each client 106 can be directly coupled to the server 104; alternatively, each client 106 can be connected to server 104 via any other suitable device, communication network, or combination thereof. For example, each client 106 can be coupled to the server 104 via one or more routers, switches, access points, and/or communication networks (as described below in connection with communication network 102). A client 106 can include a desktop computer, a mobile computer, a tablet computer, a cellular device, or any computing systems that is capable of performing computation. The server 104 can be a single server, or a network of servers, or a farm of servers in a data center.

The communication network 102 can include a network or combination of networks that can accommodate private data communication. For example, the communication network 102 can include a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. Such networks may be implemented with any number of hardware and software components, transmission media and network protocols. FIG. 1 shows the network 102 as a single network; however, the network 102 can include multiple interconnected networks listed above.

The server 104 can be coupled to a network storage system. The network storage system can include two types of network storage devices: a local network storage 108 and a remote network storage 110. The local network storage 108 and the remote network storage 110 can each include at least one physical, non-transitory storage medium.

In some embodiments, the network storage system can be provided as an enterprise system in a corporate environment For example, the communication network 102 the proxy server 104, the clients 106, and the local network storage 108 can be located in a close proximity and can be a part of a single company. In contrast, the remote network storage 110 can be operated by a third party vendor that provides a remote network storage service to the clients 106. In some cases, the proxy server 104, the clients 106, and the local network storage 108 can be located in the same building and can be coupled to one another via a local communication network. The local communication network can include a local area network (LAN,) a corporate network, and a virtual private network (VPN) associated with the corporate network. Because the local network storage 108 can be maintained by the entity that owns the data items (e.g., the company that owns the data items created/maintained/retrieved by the clients 106), and not by a third party vendor that should not have access to the data items (e.g., DROPBOX INC.), the local network storage 108 can be more secure compared to remote network storages 110 that are operated by a third party vendor.

In some embodiments, the local network storage 108 can operate under different restrictions, security measures, authentication measures, and/or policies compared to the remote network storage 110. These restrictions, security measures, authentication measures, and/or policies can be set by a system administrator. In some cases, the local network storage 108 can only be accessed by certain clients, based on the location and/or the identification of the clients. For example, parts of the local network storage 108 can only be accessed by clients coupled to the same local network as the server 104. In other cases, the local network storage 108 can use a predetermined encryption scheme for communication between the local network storage 108 and the clients. In other cases, the local network storage 108 can only be accessed by clients that have recently been authenticated.

FIG. 1 shows the local network storage 108 as separate from the communication network 102. However, the local network storage 108 can be part of communication network 102 or another communication network. FIG. 1 shows the remote network storage 110 as separate from the communication network 102. However, the remote network storage 110 can be part of the communication network 102 or another communication network. In some embodiments, the remote network storage 110 can be coupled to the Internet.

In certain embodiments, the local network storage 108 or the remote network storage 110 can be configured as a distributed storage system having multiple storage devices coupled to the communication networks. The distributed storage system can include a Distributed Replicated Block Device (DRBD,) a Distributed Network Block Device (DNBD,) a Distributed File System (DFS,) and a Hadoop Distributed File System (HDFS.)

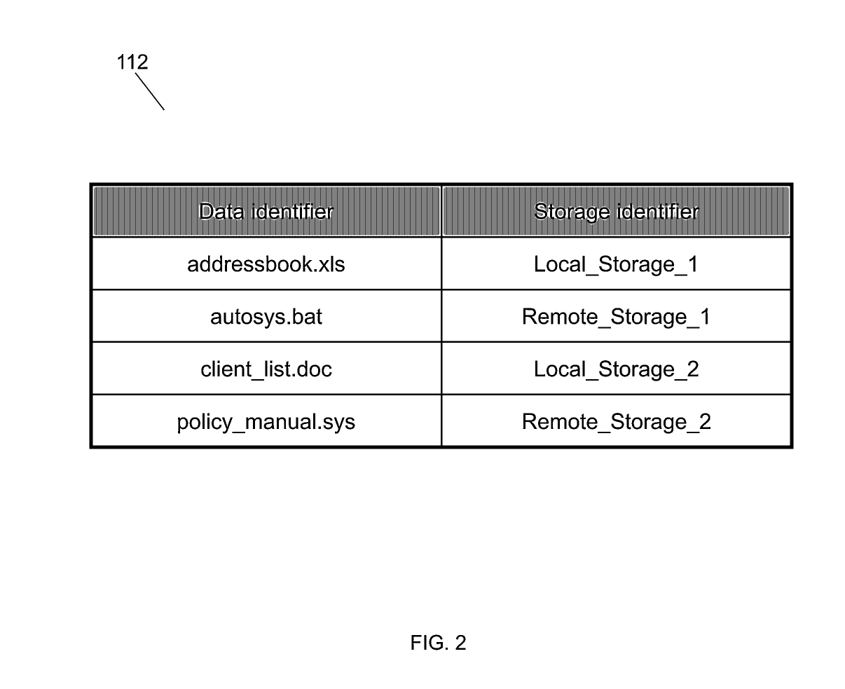

In some embodiments, the server 104 can maintain a correspondence table 112 that maintains information on which storage device is configured to maintain a data item. FIG. 2 illustrates a correspondence table in accordance with certain embodiments of the disclosed subject matter. The correspondence table 112 can include at least one entry, each entry including a data identifier and a storage identifier. The entry indicates which storage device is configured to maintain the associated data item. For example, in FIG. 2, the correspondence table 112 indicates that the data item “addressbook.xls” is stored in a local network storage 108 identified as “Local_Storage_1.” The correspondence table 112 can also indicate that the data item “client_list.doc” is stored in another local network storage 108 identified as “Local_Storage_2.” Likewise, the correspondence table 112 indicates that the data item “autosys.bat” is stored in a remote network storage 110 identified as “Remote_Storage_1.” The correspondence table 112 can also indicate that the data item “policy_manual.sys” is stored in another remote network storage 110 identified as “Remote_Storage_2.” The correspondence table 112 can include both a data identifier and a storage identifier, or any other suitable identifier or combination thereof

In some embodiments, the storage identifier can identify a particular folder in a storage device. For example, the storage identifier can identify that a data item is configured to be stored in an “Images” folder in “Local_Storage_1.” In some cases, a particular folder in the storage device can be identified as a directory. For example, an “Images” folder in “Local_Storage_1” can be identified as “Local_Storage_\Images.”

In some embodiments, an entry in a correspondence table 112 can also include a name identifier. In some cases, the name identifier can indicate one or more users that can store/retrieve a data item associated with the entry. In other cases, the name identifier can indicate one or more users that can store/retrieve a data item in a network storage associated with the entry.

In some embodiments, a data identifier can include a file name of a data item, a hash of a data item, such as a message digest, or any other signatures that can be used to identify a data item. In some embodiments, a storage identifier can include an address of a storage device, such as a fully qualified domain name (FQDN), a device unique identifier (DUID) of a storage device, a disk signature of a storage device, a volume identifier of a storage device, a file system label of a storage device, a drive serial number of a storage device, a volume serial number of a storage device, or any other signatures that can be used to identify a storage device.

In some embodiments, an entry in a correspondence table 112 can also include a name identifier. In some cases, the name identifier can indicate one or more users that can store/retrieve a data item associated with the entry. In other cases, the name identifier can indicate one or more users that can store/retrieve a data item in a network storage associated with the entry.

In some embodiments, the server 104 can intermediate the network storage system and the clients 106. When a client 106 wants to access a network storage, the client 106 can send a request to the server 104. Upon receiving the request, the server 104 can subsequently determine how the server 104 would handle the received request. For example, the server 104 can determine whether the server 104 would use a local network storage 108 or a remote network storage 110 to serve the request. Then the server 104 proceeds to serve the request using the determined network storage.

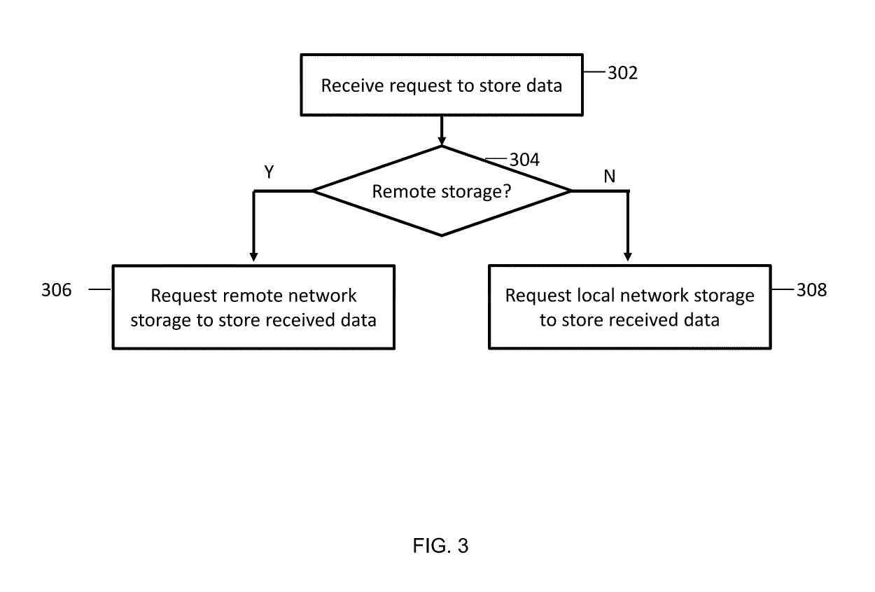

FIG. 3 illustrates a flow diagram illustrating an operation of a server when a client requests the server to store a data item in accordance with certain embodiments of the disclosed subject matter. In step 302, the server 104 receives a request, from a client, to store a data item. The request can include one or more of the following: a data item to be stored, a data item identifier, and a preferred storage device for the data item.

In step 304, the server 104 can determine whether the data item should be stored in a remote network storage 110 or a local network storage 108. In some embodiments, the server 104 can use a correspondence table 112 to determine whether the data item should be stored in a remote network storage 110 or a local network storage 108. For example, the server 104 can search the correspondence table 112 for an entry associated with the data item in the request. If the correspondence table 112 includes an entry associated with the data item in the request, the server 104 can store the data item at the network storage specified by the entry.

In another embodiment, the server 104 can use the preferred storage device for the data item, indicated in the request, to serve the request. For example, if the request indicates that the preferred storage device for the data item is a remote network storage 110, the server 104 can proceed to store the data item at the indicated remote network storage 110; if the request indicates that the preferred storage device for the data item is a local network storage 108, the server 104 can proceed to store the data item at the local network storage 108.

In other embodiments, the server 104 can analyze the request to determine whether the data item should be stored in a remote network storage 110 or a local network storage 108. The server can analyze the request using a storage determination module. In some cases, the storage determination module can analyze the data item in the request to determine whether the data item should be stored in a remote network storage 110 or a local network storage 108. The storage determination module can take into account one or more of the following factors about the data item: a type of the data item, a time of creation of the data item, a time of last modification associated with the data item, an owner of the data item, a creator of the data item, a content of the data item, and a privacy setting associated with the data item. The types of a data item can include a data file, a configuration file, a configuration logic, an image file, an audio file, a video file, a text file, and a confidential document.

For example, if the data item is about a confidential document of a company, the storage determination module can decide to store the data item in a local network storage 108; if the data item is a configuration logic for configuring a client, the storage determination module can decide to store the data item in a remote network storage 110. In another example, if the data item's privacy setting is “high,” then the storage determination module can decide to store the data item in a local network storage 108; if the data item's privacy setting is “low,” then the storage determination module can decide to store the data item in a remote network storage 110. In yet another example, if the data item is owned by a high-ranked official of a company, then the storage determination module can decide to store the data item in a local network storage 108; if the data item is owned by a low-ranked official of a company, then the storage determination module can decide to store the data item in a remote network storage 110.

In another example, the storage determination module can analyze the content of a data item to determine a network storage for the data item. The storage determination module can analyze the text and/or images within a data item and determine if the data item includes any of the predetermined words and/or images associated with a particular network storage. If the data item includes any of the predetermined words and/or images, the storage determination module can decide to use a network storage associated with the predetermined words and/or images. For instance, the storage determination module can search for words such as privileged, confidential, sensitive, do not disclose, do not distribute, and/or internal use to identify data items to be stored in a local network storage 108; the storage determination module can also search for words such as public, for distribution, for press release, and/or for marketing purposes to identify data items to be stored in a remote network storage 110. In some embodiments, the predetermined words and/or images can be configured by the operator of the server 104.

In another example, the storage determination module can analyze similar data items to determine a network storage for a particular data item. If data items, exhibiting similar characteristics as the particular data item, are stored in a local network storage 108, then the storage determination module can determine that the particular data item should also be stored in the local network storage 108. On the other hand, if data items, exhibiting similar characteristics as the particular data item, are stored in a remote network storage 110, then the storage determination module can determine that the particular data item should also be stored in the remote network storage 110. In some cases, the similarity between the data items can be determined based a content of the data items, file names associated with the data items, and a hash function output of the data items, such as message digests. In some cases, if the particular data item is a copy of another data item stored in a local network storage 108, then the storage determination module can use the local network storage 108 to store the particular data item. On the other hand, if the particular data item is a copy of another data item stored in a remote network storage 108, then the storage determination module can use the remote network storage 110 to store the particular data item.

In some embodiments, the storage determination module can analyze a status of a data item to determine a network storage for the data item. For example, the storage determination module can determine whether a user's data item has been shared with another user. Subsequently, the storage determination module deduce from the determined shared status that the data item is a public data item and determines that a network storage for the data item is the remote network storage 110. In some cases, the storage determination module deduces that the data item is a public data item only when the data item is shared with another user on a public network.

In some embodiments, the storage determination module can analyze a user input to determine a network storage for the data item. For example, a client can provide a user with an option to declare a data item as a private data item or a public data item. In some cases, the option can be a context-menu option in a Windows file manager. The user can use the context-menu option to declare that a data item is a public data item or a private data item. In other cases, the option can be two virtual folders identified as “Public” and “Private.” A user can place a data item in one of the two folders to declare that a data item is a public data item or a private data item. When the user declares a data item as a private data item, then the storage determination module can determine that the network storage for the data item is a local network storage 108. When the user declares a data item as a public data item, then the storage determination module can determine that the network storage for the data item is a remote network storage 110.

In some embodiments, the storage determination module can analyze a client sending the request to determine whether the data item should be stored in a remote network storage 110 or a local network storage 108. The storage determination module can take into account one or more of the following factors: a privacy setting associated with a user operating the client, a network in which the client is operating, a type of the client, and a corporate role of a user operating the client.

For example, the storage determination module can analyze the network protocol address, such as an Internet Protocol (IP) address, to determine the network in which the client is operating. If the client is operating in a local network that can access a local network storage 108, the server 104 can decide to serve the request using the local network storage 108; if the client is operating in a network that cannot access a local network storage 108, the server 104 can decide to serve the request using a remote network storage 110. In another example, if a privacy setting associated with the client is “high”, then the server 104 can decide to serve the request using a local network storage 108; if a privacy setting associated with the client is “low”, then the server 104 can decide to serve the request using a remote network storage 110.

In step 306, if the server 104 decides to store the data item in a remote network storage 110, the server 104 can send a request to the remote network storage 110 to store the data item. The request can include one or more of the following: the data item, the data item identifier, and a storage identifier of the remote network storage 110.

In step 308, if the server 104 decides to store the data item in a local network storage 108, the server 104 can send a request to the local network storage 110 to store the data item. The request can include one or more of the following: the data item, the data item identifier, and a storage identifier of the local network storage 108.

In some embodiments, the storage determination module can populate the correspondence table 112. For example, once the storage determination module determines a storage device for maintaining a data item, the storage determination module can search the correspondence table 112 to determine if the correspondence table 112 includes an entry associated with the data item. If the correspondence table 112 includes an entry associated with the data item, the storage determination module can update the entry to indicate that the data item is currently maintained in the newly determined storage device; if the correspondence table 112 does not include an entry associated with the data item, the storage determination module can create an entry associated with the data item in the correspondence table 112, indicating that the data item is currently maintained in the determined storage device.

In some embodiments, the server 104 can determine a network storage for a data item interactively with a user, instead of automatically determining a network storage for a data item. For example, the server 104 can use the storage determination module to determine one or more appropriate network storages for a data item, and recommend the determined one or more network storages to the user at a client. In response, the user can review the recommended network storages and select one of the recommended network storages to store a data item.

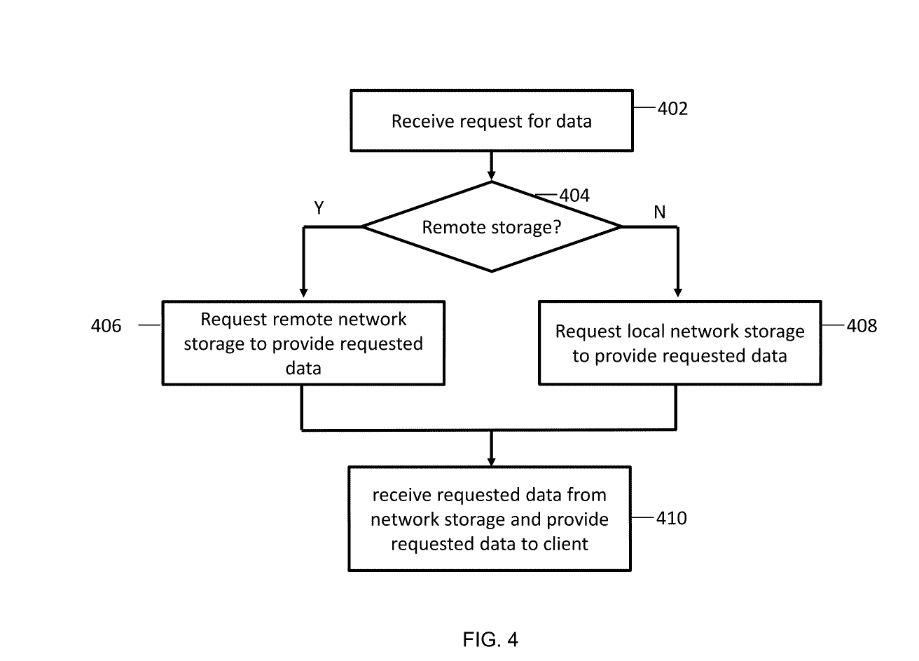

FIG. 4 illustrates a flow diagram illustrating an operation of a server when a client requests the server to retrieve a data item in accordance with certain embodiments of the disclosed subject matter. In step 402, the server 104 receives a request, from a client, to retrieve a data item. The request can include a data item identifier. In step 404, the server 104 can identify the network storage that maintains the data item associated with the data item identifier. In some embodiments, the server 104 can use the correspondence table 112 to identify the network storage that maintains the data item. For example, the server 104 can retrieve an entry having the data item identifier from the correspondence table 112, and identify the network storage associated with the data item identifier. In other embodiments, the server 104 can the storage determination module, as discussed above in conjunction with FIG. 3, to determine the storage associated with the data item.

In step 406, if the server 104 determines that the data item associated with the received data item identifier is maintained by a remote network storage 110, the server 104 can send a request to the remote network storage 110 to provide the data item associated with the data item identifier. In step 408, if the server 104 determines that the data item associated with the received data item identifier is maintained by a local network storage 108, the server 104 can send a request to the local network storage 108 to provide the data item associated with the data item identifier. In step 410, the server 104 can receive the requested data item from the network storage, and provide the received data item to the client that requested the data item.

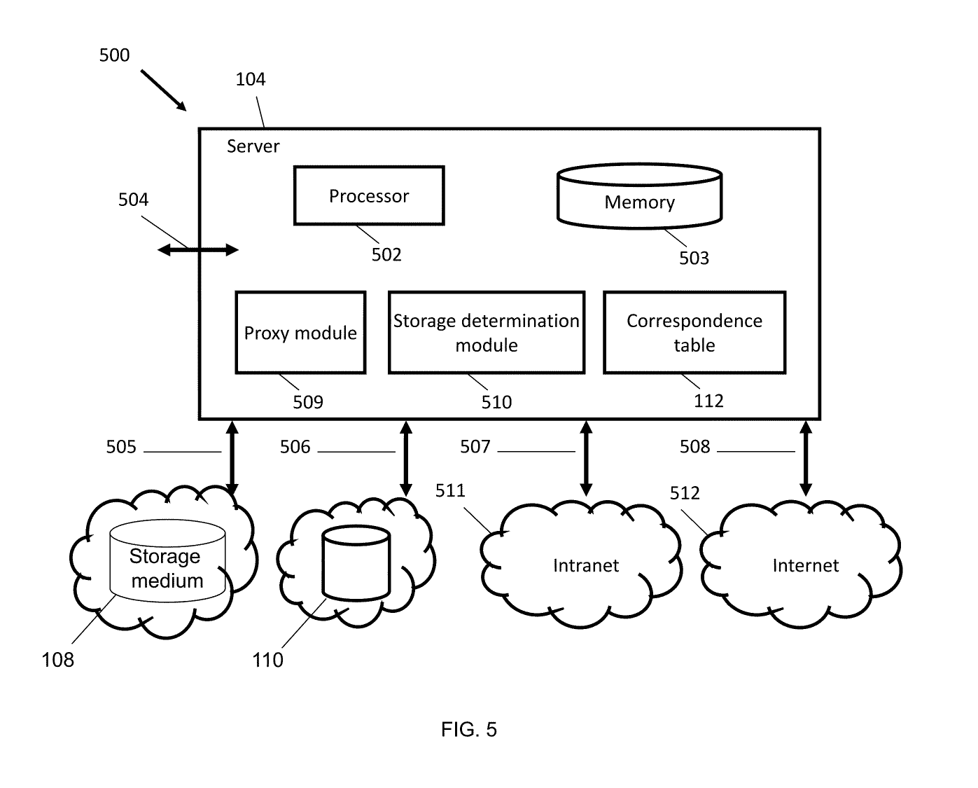

FIG. 5 is a block diagram of a server device in accordance with certain embodiments of the disclosed subject matter. The block diagram 500 shows a server 104, which includes a processor 502, a memory 503, interfaces 504-508, a proxy module 509, a storage determination module 510, a correspondence table 112, a local network storage 108, a remote network storage 110, an Intranet 511, and the Internet 512. The server 104 can communicate with client devices 106 (not shown) via the interface 504; the server 104 can communicate with the local network storage 108 via the interface 505; the server 104 can communicate with the remote network storage 110 via the interface 506; the server 104 can communicate with the Intranet 511 via the interface 507; and the server 104 can communicate with the Internet 512 via the interface 508. The interfaces 504-508 are shown as separate interfaces but may be the same physical interface.

The proxy module 509 can be configured to intermediate access to network storage devices 108 and 110. The proxy module 509 can be configured to receive a request to provide access to a network storage for a data item. Upon receiving the request, the proxy module 509 can identify a network storage to be used for the data item, and communicate with the identified network storage to serve the request. For example, the proxy module 509 can receive a request to store a data item in a network storage. Upon receiving the request, the proxy module 509 can select one of the local network storage 108 and the remote network storage 110, and request the selected network storage to store the data item. In another example, the proxy module 509 can receive a request to retrieve a data item from a network storage. The proxy module 509 can identify which one of the local network storage 108 and the remote network storage 110 maintains the requested data item, and request the identified network storage to retrieve the data item.

In some embodiments, the proxy module 509 can use the storage determination module 510 to identify a network storage to be used for serving a request from a client. In some cases, storage determination module 510 can analyze the client sending the request to identify the network storage to be used for serving the request. In other cases, the storage determination module 510 can analyze the data item associated with the request to identify the network storage to be used for serving the request.

In some embodiments, the proxy module 509 can use the correspondence table 112 to identify a network storage for serving the received request. The correspondence table 112 can maintain entries, where each entry associates a data item with a storage identifier that is configured to maintain the data item.

The modules 509, 510 can be implemented in software using the memory 304, and the correspondence table 112 can be implemented as a database stored in the memory 304. The memory 503 can be a non-transitory computer readable medium, flash memory, a magnetic disk drive, an optical drive, a programmable read-only memory (PROM), a read-only memory (ROM), or any other memory or combination of memories. The software can run on a processor 502 capable of executing computer instructions or computer code. The processor 502 might also be implemented in hardware using an application specific integrated circuit (ASIC), programmable logic array (PLA), field programmable gate array (FPGA), or any other integrated circuit.

FIG. 5 shows a server 104 having modules 509, 510 that perform the above-described operations in accordance with certain embodiments of the disclosed subject matter. The server 104 may include additional modules, less modules, or any other suitable combination of modules that perform any suitable operation or combination of operations.

The interfaces 504-508 provide an input and/or output mechanism to communicate over a network. The interfaces 504-508 enable communication with clients, as well as other network nodes in the communication network 102. The interfaces 504-508 can be implemented in hardware to send and receive signals in a variety of mediums, such as optical, copper, and wireless, and in a number of different protocols some of which may be non-transient.

The server 104 can operate using an operating system (OS) software. In some embodiments, the OS software is based on a Linux software kernel and runs specific applications in the server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources can be dynamically deployed to meet the requirements in some embodiments.

The server's software can be divided into a series of tasks that perform specific functions. These tasks communicate with each other as needed to share control and data information throughout the server 104. A task can be a software process that performs a specific function related to system control or session processing. Three types of tasks operate within the server 104 in some embodiments: critical tasks, controller tasks, and manager tasks. The critical tasks control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem includes critical tasks, controller tasks, and manager tasks. Some of the subsystems that run on the server 104 include a system initiation task subsystem, a high availability task subsystem, a shared configuration task subsystem, and a resource management subsystem.

The system initiation task subsystem is responsible for starting a set of initial tasks at system startup and providing individual tasks as needed. The high availability task subsystem works in conjunction with the recovery control task subsystem to maintain the operational state of the server 104 by monitoring the various software and hardware components of the server 104. Recovery control task subsystem is responsible for executing a recovery action for failures that occur in the server 104 and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

Shared configuration task subsystem can provide the server 104 with an ability to set, retrieve, and receive notification of server configuration parameter changes and is responsible for storing configuration data for the applications running within the server 104. A resource management subsystem is responsible for assigning resources (e.g., processor and memory capabilities) to tasks and for monitoring the task's use of the resources.

In some embodiments, the server 104 can reside in a data center and form a node in a cloud computing infrastructure. The server 104 can also provide services on demand. A module hosting a client is capable of migrating from one server to another server seamlessly, without causing program faults or system breakdown. The server 104 on the cloud can be managed using a management system.

The client 106 can include user equipment. The user equipment communicates with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

The client 106 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities. The client 106 is configured with one or more processors that process instructions and run software that may be stored in memory. The processor also communicates with the memory and interfaces to communicate with other devices. The processor can be any applicable processor such as a system-on-a-chip that combines a CPU, an application processor, and flash memory. The client 106 can also provide a variety of user interfaces such as a keyboard, a touch screen, a trackball, a touch pad, and/or a mouse. The client 106 may also include speakers and a display device in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method comprising:
receiving, at a server, a request from a client coupled to a local communication network to provide access to a network storage system, wherein the request comprises a data item identifier, wherein the network storage system comprises a local network storage, coupled to the local communication network, and a remote network storage, coupled to a public communication network;
identifying, at the server, based on the request, one of the local network storage and the remote network storage for serving the request; and
providing the request to the identified one of the local network storage and the remote network storage to provide the client with an access to the identified one of the local network storage and the remote network storage.

2. The method of claim 1, wherein receiving the request to provide access to the network storage system comprises receiving a request to store a data item in the network storage system, wherein the request to store the data item comprises the data item, and wherein identifying one of the local network storage and the remote network storage comprises analyzing the data item in the request.

3. The method of claim 2, wherein analyzing the data item in the request comprises determining a type of the data item, and wherein if the determined type of the data item is a file type, the method further comprising identifying the local network storage for serving the request.

4. The method of claim 1, wherein the local communication network comprises a local area network, a private communication network, or a virtual private network.

5. The method of claim 1, further comprising updating a correspondence table to maintain a correspondence between the data item identifier and the identified network storage.

6. The method of claim 1, wherein identifying one of the local network storage and the remote network storage comprises analyzing a privacy setting associated with the client from which the request is received.

7. An apparatus for providing a network storage system, the apparatus comprising:
one or more interfaces configured to provide communication with a client device and the network storage system, wherein the network storage system comprises a local network storage, coupled to a local communication network, and a remote network storage, coupled to a public communication network; and
a processor, in communication with the one or more interfaces, configured to run a module stored in memory that is configured to:
receive a request, from the client, to provide access to the network storage system, wherein the request comprises a data item identifier;
identify, based on the request, one of the local network storage and the remote network storage for serving the request; and
provide the request to the identified one of the local network storage and the remote network storage to provide the client with an access to the identified one of
the local network storage and the remote network storage.

8. The apparatus of claim 7, wherein the request to provide access to the network storage system comprises a store request to store a data item in the network storage system, wherein the store request to store the data item includes the data item, and wherein the module is configured to identify one of the local network storage and the remote network storage by analyzing the data item in the request.

9. The apparatus of claim 8, wherein the module is configured to analyze the data item in the request by determining a type of the data item, and wherein if the determined type of the data item is a file type, the module is further configured to identify the local network storage for serving the request.

10. The apparatus of claim 8, wherein the local communication network comprises a local area network, a private communication network, or a virtual private network.

11. The apparatus of claim 7, wherein the module is configured to provide a correspondence table, the correspondence table configured to maintain an entry indicating a correspondence between the data item identifier and a storage device identifier of the network storage system configured to maintain the data item.

12. The apparatus of claim 7, wherein the module configured to identify one of the local network storage and the remote network storage by determining a network from which the client sent the request, and wherein if the client sent the request from the local communication network, the module is further configured to identify the local network storage for serving the request.

13. The apparatus of claim 7, wherein the module is configured to identify one of the local network storage and the remote network storage by analyzing a privacy setting of the client from which the request is received.

14. The apparatus of claim 7, wherein the module is configured to identify one of the local network storage and the remote network storage by analyzing a type of a data item associated with the data item identifier, and wherein if the type of the data item is a file, the module configured to identify the local network storage for serving the request.

15. The apparatus of claim 7, wherein the local network storage comprises a distributed storage system.

16. A non-transitory computer readable medium having executable instructions operable to cause an apparatus to:
receive a request, from a client, to provide access to a network storage system, wherein the request comprises a data item identifier, and wherein the network storage system comprises a local network storage, coupled to a local communication network, and a remote network storage, coupled to a public communication network;
identify, based on the request, one of the local network storage and the remote network storage for serving the request; and
provide the request to the identified one of the local network storage and the remote network storage to provide the client with an access to the identified one of the local network storage and the remote network storage.

17. The computer readable medium of claim 16, wherein the request to provide access to the network storage system comprises a request to store a data item in the network storage system, wherein the request to store the data item further comprises the data item, and wherein the computer readable medium further comprises executable instructions operable to cause the apparatus to analyze the data item in the request to identify one of the local network storage and the remote network storage for serving the request.

18. The computer readable medium of claim 16, further comprising executable instructions operable to cause the apparatus to update a correspondence table to maintain a correspondence between the data item identifier and the identified network storage.

19. The computer readable medium of claim 16, further comprising executable instructions operable to cause the apparatus to analyze a privacy setting the client from which the request is received to identify one of the local network storage and the remote network storage for serving the request.

20. The computer readable medium of claim 16, wherein the local communication network comprises a local area network, a private communication network, or a virtual private network.
